(19) United States
(12) Patent Application Publication
(10) Pub. No.: US 2022/0402028 A1
(43) Pub. Date: Dec. 22, 2022

(54) METHOD FOR PRODUCING A METAL COMPONENT HAVING A SECTION WITH A HIGH ASPECT RATIO

(71) Applicant: Heraeus Amloy Technologies GmbH, Hanau (DE)

(72) Inventor: Moritz STOLPE, Hanau (DE)

(21) Appl. No.: 17/754,590

(22) PCT Filed: Oct. 9, 2020
(86) PCT No.: PCT/EP2020/078390

§ 371 Date: Apr. 6, 2022

(30) Foreign Application Priority Data
Oct. 11, 2019 (EP) 19202669.8

(51) Int. Cl. B22F 7/08; B33Y 10/00; B33Y 70/00

(52) U.S. Cl. CPC B22F 7/08; B33Y 10/00; B33Y 70/00; B22F 2301/052; B22F 2301/058; B22F 10/28

(57) ABSTRACT

The invention relates to a method for producing a metal molded body, said molded body comprising (i) a metal substrate and (ii) a section, provided on the metal substrate, having a high aspect ratio and containing an amorphous metal alloy, wherein the section with the high aspect ratio and containing the amorphous metal alloy is applied to the metal substrate via additive manufacturing.

The present invention relates to a method for producing a metal molded body, which comprises a metal substrate and a section, applied to the substrate, having a high aspect ratio.

Amorphous metals have advantageous mechanical properties such as, for example, a high degree of strength and hardness. Moreover, they exhibit a high degree of corrosion resistance. Therefore, amorphous metals are interesting materials for the production of components for which these properties are relevant.

For example, it can be advantageous for components that, at least in sections, have thin-walled regions and/or regions with a high aspect ratio, if such sections contain an amorphous metal. Depending upon the application of the component, the presence of an amorphous metal can improve the mechanical behavior of the thin-walled sections—particularly when these regions are exposed to higher mechanical loads.

WO 2012/031022 A2 describes the production of a molded body with a high aspect ratio which contains an amorphous metal. The production is carried out by thermoplastic molding. In this case, an amorphous metal blank to be formed is heated to a temperature that is between the glass transition temperature and the crystallization temperature, and is converted into the desired shape by pressing. Thermoplastic pressing requires the use of a negative mold, which in turn makes the production of complex geometries more difficult.

A component having a thin-walled section with a high aspect ratio is, for example, the so-called flex spline of a Harmonic Drive gear. Further exemplary components with a thin-walled section having a high aspect ratio are tools that have a thin sheet or a thin blade (e.g., a scalpel).

WO 2015/156797 A1 describes a Harmonic Drive gear whose flex spline contains an amorphous metal. The amorphous metal flex spline is produced by means of thermoplastic molding or casting.

US 2016/339509 A1 describes the production of a molded body containing an amorphous metal alloy by casting, wherein a molten metal alloy is cast in a gap which is present between two substrates that are movable relative to one another and is cooled rapidly.

In the case of amorphous components that have a high aspect ratio (i.e., a high value for the ratio of height to material thickness), the production by means of a casting method is very problematic. To ensure that the melt of the alloy used solidifies amorphously, a sufficiently high cooling rate must be realized. On the other hand, before its solidification, the melt should already have completely filled the mold. In practice, however, it has been found that many alloys do not meet these two requirements (i.e., amorphous solidification when the casting mold is completely filled). In the course of the rapid cooling, a quick increase in viscosity of the melt occurs, whereby filling structures with a high aspect ratio (e.g., thin-walled structures or narrow channels) is made more difficult.

The production of amorphous metal molded bodies via an additive manufacturing method is known.

WO 2008/039134 A1 describes the production of metallic, amorphous molded bodies via a powder-bed-based, beam melting method.

US 2018/257141 A1 describes the production of a metallic flex spline via an additive manufacturing method. The entire component is produced by additive manufacturing. Since the relatively voluminous and solid base plate of the flex spline is also produced via the additive manufacturing method, the production of the flex spline is time-consuming and cost-intensive.

DE 10 2008 012 064 A1 describes a method for producing a multipart molded body. In this method, initially, a substrate or base body is produced by casting or machining. Subsequently, a first section is applied on a first surface of the base body via an additive manufacturing method, the base body is rotated, and a further section is applied on a second surface of the rotated base body via additive manufacturing. The use of amorphous metals for the additively-manufactured sections is not mentioned.

WO 2018/148010 A1 describes a method for producing a component of a turbine engine, wherein an annular or conic molded section is applied to a forged substrate or base body by an additive manufacturing method. The use of amorphous metals for the additively-manufactured conical sections is not mentioned.

EP 2 957 367 A1 describes a method for producing a molded body, wherein, first, a substrate body is provided, and a further section is added to this substrate body by additive manufacturing, so that the final molded body is obtained.

An aim of the present invention is the production of a metal molded body which has a section with a high aspect ratio by means of a method that can be performed as efficiently as possible (for example, in a time-saving and cost-efficient manner) and leads to a component with advantageous mechanical properties.

The aim is achieved by a method for producing a metal molded body, the molded body comprising (i) a metal substrate and (ii) a section, provided on the metal substrate, having a high aspect ratio and containing an amorphous metal alloy, wherein the section with a high aspect ratio and containing the amorphous metal alloy is applied to the metal substrate via additive manufacturing.

Preferably, the metal substrate is produced by means of a non-additive metallurgical method.

The non-additive metallurgical method is, for example, casting, machining, thermoplastic molding, or a powder metallurgical method. Exemplary powder metallurgical methods for producing the metal substrate are pressing (e.g., hot pressing or isostatic pressing—in particular, hot isostatic pressing (HIP))—metal powder injection molding, and/or sintering. The non-additive metallurgical method can, for example, also be at least two-staged and comprise two or more of the aforementioned methods. For example, the production of the metal substrate comprises casting and, subsequently, thermoplastic molding.

The production of the metal substrate by a conventional metallurgical method (e.g., casting) instead of additive manufacturing saves time and thus also makes the entire method more cost-efficient. Since, on the other hand, the section of the molded body having a high aspect ratio is produced by additive manufacturing using an amorphously-solidifying metal alloy, amorphous structures with a high aspect ratio, e.g., thin-walled hollow bodies, can be realized which cannot be produced by conventional methods (e.g., casting methods). Due to the presence of the amorphous metal alloy in the section with a high aspect ratio, it has good mechanical properties—in particular, high elasticity—even in the case of a low wall thickness.

The metal substrate can contain an elemental metal and/or a metal alloy. The selection of suitable elemental metals or metal alloys can be made by a person skilled in the art with consideration of the planned use of the molded body, based upon his general knowledge of the field.

In the context of the present invention, the term, “metal,” comprises both an elemental metal and a metal alloy.

The metal substrate can contain an amorphous metal (in particular, an amorphous metal alloy) and/or a crystalline metal (in the form of an elemental metal or a metal alloy). It is also possible within the scope of the present invention for the metal substrate to contain an amorphous metal alloy, which functions as a matrix and in which a crystalline metal is dispersed.

For example, the metal substrate is made of aluminum or an aluminum alloy, steel, titanium, or a titanium alloy.

The specific shape of the metal substrate depends upon the planned use of the molded body. For example, the metal substrate of the molded body is in the form of a plate (for example, a base plate of a flex spline or a housing), a toothed ring, a housing, or a cutting region of a milling head. The substrate can also, for example, be a part of a medical device, a surgical instrument (for example, a scalpel), or forceps.

Before applying the section with a high aspect ratio via additive manufacturing, the metal substrate can optionally be subjected to a surface treatment. For example, a coating of a metal can be applied, which improves the adhesion of the amorphous metal alloy to the substrate.

The metal substrate functions as a carrier on which a section is applied via additive manufacturing, which section has a high aspect ratio and contains an amorphous metal alloy. The metal substrate is part of the molded body to be produced with the method according to the invention.

Suitable additive manufacturing methods for producing metallic amorphous structures are known to the person skilled in the art. For example, the additive manufacturing method is powder-bed-based beam melting, deposition welding (e.g., powder- or wire-deposition welding), liquid metal jetting, an extrusion method, or binder jetting. Additive manufacturing methods are also summarized in, for example, the EN ISO/ASTM 52921:2017 standard. In a preferred embodiment, the additive manufacturing of the section with a high aspect ratio takes place by means of powder-bed-based laser or electron beam melting. The additive manufacturing of amorphous metal molded bodies by powder-bed-based beam melting is described in, for example, L. Löber et al., Materials Today, Vol. 16, January/February 2013, p. 37 ff.

In the additive manufacturing method, the section with a high aspect ratio is constructed on the basis of the predetermined CAD data, layer by layer. For example, in the case of powder-bed-based laser or electron beam melting, a metal substrate (which preferably has previously been produced by a non-additive metallurgical method) is introduced into the installation space of a corresponding device and is optionally fixed in the installation space by suitable measures (e.g., by a powder bed surrounding the metal substrate); powder layers of the metal alloy are applied sequentially, wherein the first powder layer is applied on a surface of the metal substrate; in each applied powder layer, the metal alloy is melted in the regions that form the section with a high aspect ratio (for example, the wall of the hollow body) by the action of the laser beam or electron beam and subsequently solidifies at least partially amorphously.

Suitable metal alloys, which can solidify in amorphous form in an additive manufacturing process, are known to the person skilled in the art.

For example, the amorphous metal alloy is a transition-metal-based alloy, an Al-based alloy, or an Mg-based alloy. The transition-metal-based alloy is, for example, a Zr-based alloy, a Cu-based alloy, an Fe-based alloy, a Ti-based alloy, an Ni-based alloy, or a precious-metal-based alloy (e.g., a Pt- or Pd-based alloy). A Zr-based alloy is an alloy that contains Zr as the main constituent (in atom %). In other words: In a Zr-based alloy, Zr is the element present at the highest concentration, expressed in atom %. The same also applies to the other aforementioned alloys. For example, a Cu-based alloy is an alloy whose main component (in atom %) is copper.

Overviews of amorphous metal alloys are found in, for example, the following publications:
“Bulk Metallic Glasses-An Overview,” M. Miller and P. Liaw, eds., Springer, pp. 2-17 and 210-222
A. L. Greer, Materials Today, January-February 2009, Vol. 12, pp. 14-22-A. Inoue et al., Materials, 2010, 3, pp. 5,320-5,339

Exemplary combinations of elements in amorphously-solidifying metal alloys are as follows:

Late transition metals and non-metals, wherein the late transition metal constitutes the base, e.g., Ni—P, Pd—Si, Au—Si—Ge, Pd—Ni—Cu—P, Fe—Cr—Mo—P—C—B

Early and late transition metals, wherein both metals can constitute the base, such as, for example, Zr—Cu, Zr—Ni, Ti—Ni, Zr—Cu—Ni—Al, Zr—Ti—Cu—Ni—Be

Metals from group B with rare earth metals, wherein the metal B constitutes the base, such as, for example, Al—La, Al—Ce, Al—La—Ni—Co, La—(Al/Ga)—Cu—Ni

Metals from group A with late transition metals, wherein the metal A constitutes the base, such as, for example, Mg—Cu, Ca—Mg—Zn, Ca—Mg—Cu

In addition to one or more metal alloying elements, the transition-metal-based alloy can optionally also include one or more metalloids (e.g., B, Si, Ge, As, Sb, or Te, or a combination of at least two of these elements) and/or one or more non-metal elements (e.g., P or S) as alloying elements.

For example, the amorphous metal alloy can be a Zr—Cu—Al—Nb alloy. Preferably, this Zr—Cu—Al—Nb alloy, except for zirconium, additionally has 23.5-24.5 wt % copper, 3.5-4.0 wt % aluminum, and 1.5-2.0 wt % niobium, wherein the weight fractions add up to 100 wt %. The last-mentioned alloy is commercially available under the name AMZ4® from Heraeus Deutschland GmbH. In a further exemplary embodiment, the amorphous metal alloy can contain the elements zirconium, titanium, copper, nickel, and aluminum. Preferred alloy compositions are, for example, Zr_{52.5}Ti₅Cu_{17.9}Ni_{14.6}Al₁₀ and Zr_{59.3}Cu_{28.8}A110.4Nb_{1.5}, wherein the indices indicate atom % of the respective elements in the alloy. Another group of alloys can contain, for example, the elements Zr, Al, Ni, Cu, and Pd, and in particular Zr₆₀Al₁₀Ni₁₀Cu₁₅Pd₅. Another suitable group of alloys contains, for example, at least 85 wt % Pt as well as Cu and phosphorus, wherein the alloy can also contain Co and/or nickel—for example, Pt_{57.5}Cu_{14.5}Ni₅P₂₃ (indices in atom %). Another suitable group of alloys is a transition-metal-based alloy containing sulfur as an alloying element. Such sulfur-containing, transition-metal-based alloys are described in, for example, EP 3 447 158 A1.

The material forming the section with a high aspect ratio can, for example, consist of one or more amorphous metal alloys. In the context of the present invention, however, it is also possible for the section to contain, in addition to the amorphous metal alloy, a crystalline metal (for example, one or more crystalline metal alloys). For example, the amorphous metal alloy can function as a matrix, in which one or more crystalline metal alloys are dispersed. The advantageous properties of the amorphous metals also come into effect with these composite structures.

As is known to the person skilled in the art, an amorphous metal alloy in dynamic differential calorimetry (DSC) shows a glass transition and an exothermic heat effect during the transition into the crystalline state (enthalpy of crystallization), whereas no sharp diffraction peaks (“Bragg peaks”) in the X-ray diffractometry can be seen.

Preferably, the section having a high aspect ratio and containing the amorphous metal alloy has a crystallinity of less than 50%, more preferably less than 25%, and even more preferably less than 10%, or is even completely amorphous. The crystalline fraction is determined by DSC as the ratio of the crystallization enthalpy of the material forming the section to the crystallization enthalpy of a completely amorphous reference sample (i.e., no diffraction peaks (Bragg peaks) in the X-ray diffractogram).

The section of the molded body containing the amorphous metal alloy and having a high aspect ratio is, for example, a hollow body. In the context of the present invention, however, any other geometric shapes are also possible (e.g., rod-shaped, blade-shaped, or a sheet of a tool).

The exact shape of the section with a high aspect ratio present on the metal substrate depends upon the planned use of the molded body. Since the section is produced via an additive manufacturing method, complex geometries may also be realized, if necessary.

For example, the hollow body is a tubular hollow body. The tube can have a round or even a cornered or angular cross-section. However, other shapes of the hollow body are also possible within the scope of the present invention. The hollow body can be a closed or open hollow body. The wall of the hollow body can be designed, for example, as solid or in the form of a lattice structure.

In the case of the hollow body, the wall thereof contains the amorphous metal alloy.

The section containing the amorphous metal alloy preferably has an aspect ratio of at least 10, and more preferably at least 20. For example, the aspect ratio is in the range of 10 to 1,000, and more preferably 20 to 500.

The aspect ratio of the section of the molded body present on the substrate results from the ratio of the height H of the section to the minimum material thickness Dₘᵢₙ of the section.

If the section is, for example, a hollow body (for example, a cylindrical hollow body), the minimum material thickness results from the minimum wall thickness of the hollow body. The hollow body applied to the metal substrate of the molded body thus preferably has a height H and a minimum wall thickness Dₘᵢₙ, wherein H/Dₘᵢₙ≥10, and preferably ≥20; for example, 1,000≥H/Dₘᵢₙ≥10 or 500≥H/Dₘᵢₙ≥20.

The method according to the invention is particularly advantageous if the section, having a high aspect ratio, applied to the metal substrate has a relatively low material thickness.

For example, the material thickness of the section with a high aspect ratio containing the amorphous metal alloy is in the range of 0.05 mm to 50 mm, preferably 0.05 mm to 5 mm, and more preferably 0.05 mm to 2 mm. If the section is a hollow body, its wall thickness is thus, for example, 0.05 mm to 50 mm, preferably 0.05 mm to 5 mm, and more preferably 0.05 mm to 2 mm.

The molded body produced by the method according to the invention is, for example, the flex spline of a Harmonic Drive gear, a milling head or a toothed wheel (non-additively-manufactured metal substrate) with a tubular bushing (additively-manufactured hollow body) lying thereon, a medical device, a surgical instrument (for example, a scalpel), or forceps.

1. A method for producing a metal molded body, the molded body comprising:
(i) a metal substrate and
(ii) a section, present on the metal substrate, having a high aspect ratio and containing an amorphous metal alloy,
wherein the section with a high aspect ratio and containing the amorphous metal alloy is applied to the metal substrate via additive manufacturing.

2. The method according to claim 1, wherein the metal substrate is produced via a non-additive metallurgical method.

3. The method according to claim 2, wherein the non-additive metallurgical method is casting, machining, thermoplastic molding, or a powder metallurgical method, or a combination of at least two of these methods.

4. The method according to claim 1, wherein the metal substrate contains a crystalline metal and/or an amorphous metal.

5. The method according to claim 1, wherein the metal substrate is a plate, a housing, a toothed ring, or a cutting region of a milling head.

6. The method according to claim 1, wherein the additive manufacturing is powder-bed-based beam melting, deposition welding, liquid metal jetting, an extrusion method, or binder jetting.

7. The method according to claim 6, wherein the powder-bed-based beam melting is powder-bed-based laser or electron beam melting.

8. The method according to claim 1, wherein the section with a high aspect ratio and containing the amorphous metal alloy has an aspect ratio of at least 10.

9. The method according to claim 1, wherein the section with a high aspect ratio and containing the amorphous metal alloy has a material thickness in the range of 0.05 mm to 50 mm.

10. The method according to claim 1, wherein the section with high aspect ratio and containing the amorphous metal alloy is a hollow body, in particular, a tubular hollow body, a rod-shaped section, or a sheet or blade of a tool.

11. The method according to claim 1, wherein the amorphous metal alloy present in the section with a high aspect ratio is a transition-metal-based alloy, an Al-based alloy, or an Mg-based alloy.

12. The method according to claim 1, wherein the molded body is a flex spline of a Harmonic Drive gear, a milling head or a gear wheel with a tubular bushing lying thereon, a medical device, a surgical instrument, or forceps.
